(19) United States
(12) Patent Application Publication
(10) Pub. No.: US 2008/0272243 A1
(43) Pub. Date: Nov. 6, 2008

(54) Control apparatus for an aircraft

(76) Inventor: Walter Ernst Decker, Windsbach (DE)

Correspondence Address: DILWORTH & BARRESE, LLP, 333 EARLE OVINGTON BLVD., SUITE 702, UNIONDALE, NY, 11553, US

(21) Appl. No.: 11/541,076

(22) Filed: Sep. 29, 2006

(30) Foreign Application Priority Data
Sep. 30, 2005 (DE) UM202005015434.2

(51) Int. Cl. B64C 13/04

(52) U.S. Cl. 244/221

(57) ABSTRACT

The present invention relates to a control apparatus for an aircraft comprising a multiaxially tiltable joystick for the actuation of at least two control transducers for the pitch and roll control of the aircraft, with the control transducers being associated with two control shafts which are connected to the joystick via a Cardan-like joint with two pivot axes aligned transversely to one another, with a pitch movement of the joystick being able to be converted via said joint into a rotation of the one control shaft and a roll movement of the joystick being able to be converted into a rotation of the other control shaft. In accordance with the invention, the control apparatus is characterized in that the two control shafts are rotatably journaled in a fixed manner at a common rack and in that the joint in each case has a freewheel with respect to the control shafts for tilt movements of the joystick in a plane parallel to the respective control shaft.

### BACKGROUND OF THE INVENTION

The present invention relates to a control apparatus for an aircraft comprising a multiaxially tiltable joystick for the actuation of at least two control transducers for the pitch and roll control of the aircraft, with the control transducers being associated with two control shafts which are connected to the joystick via a Cardan-like joint with two pivot axes aligned transversely to one another, with a pitch movement of the joystick being able to be converted via said joint into a rotation of the one control shaft and a roll movement of the joystick being able to be converted into a rotation of the other control shaft.

Joysticks of aircraft are typically tiltable biaxially, that is around a transverse axis to the front and rear, on the one hand, and around a longitudinal axis to the left and right, on the other hand. Control shafts are actuated by the corresponding tilt movements and their rotation is detected by transducers and is transformed into control movements of the aircraft, in particular for pitch and roll control. It is known for this purpose from DE 38 25 809, for example, to journal the joystick by means of a Cardan joint to which the two control shafts are connected. The biaxial movability of the joystick brings along the circumstance with this already known solution that one of the two control shafts cannot be journaled in a fixed manner since it has to participate in the pivot movements of the other control shaft. Accordingly, the control components coupled to this co-movable control shaft such as transducers, dampers and restoring springs and the like are likewise movable so that their assembly and the cable routing have to be made accordingly to permit the movements. The problem is exacerbated as the complexity of the control apparatus increases. So-called active joystick controls of aircraft include an electrical simulation of the control feeling as is present in mechanically coupled joysticks. For this purpose, actuating motors are connected to the control shafts to simulate counter-pressure, adjustment movements or acceleration phenomena at the joystick, as is described, for example, in DE 694 16 969 T2. Moreover, in aircraft with two joysticks for the pilot and the co-pilot, the control movements at the one joystick are simulated at the other joystick, or the latter tracks said movements, cf. EP 0 844 171 B1 or EP 0 383 663 B2. Actuator motors and various other components such as sensors, potentiometers, etc. are also installed at the control shafts for such coupled control systems.

### SUMMARY OF THE INVENTION

Starting from this, it is the underlying object of the present invention to provide an improved control apparatus of the aforesaid type which avoids disadvantages of the prior art and further develops the latter in an advantageous manner. A simple control apparatus with few components should preferably be provided which facilitates the attachment of the sensors and actuators and permits a simple conversion of the sensor and actuator components for different control designs.

This object is solved in accordance with the invention by a control apparatus in accordance with claim 1. Preferred aspects of the invention are the subject of the dependent claims.

It is proposed for this purpose to give the Cardan joint-like connection of the joystick with the two control shafts an additional degree of freedom in comparison with a classical Cardan joint which uncouples the joystick from the control shaft for roll movements with respect to pitch movements and uncouples the joystick from the control shaft for pitch movements with respect to roll movements. In accordance with the invention, the two control shafts are rotatably journaled in a fixed manner at a common frame. With respect to the control shafts, the joint in each case has a freewheel for tilt movements of the joystick in a plane parallel to the respective control shaft. A pivoting of the joystick around its pitch axis to the front and rear therefore only effects a rotation of the pitch control shaft, whereas a tilting of the joystick to the left or right around its roll axis only effects a rotary movement of the roll control shaft. The respective other control shaft does not undergo any rotation or any pivoting.

The two control shafts advantageously have fixed outputs so that the assembly of control modules associated with the respective control shafts is considerably simplified. No moving connector lines have to be provided since the sensors and actuators can be installed in a fixed manner at the housing. In addition, low moving masses can be achieved since attached sensor or actuator components are not moved along. In addition, a high reliability and a simple inner structure of the control apparatus can be achieved by a low number of components. Above all things, however, a modular utilization of the control apparatus as an active or passive joystick is possible since the components required in each case for the different embodiments of the control can be attached and/or replaced in a modular form.

The additional degree of freedom of the Cardan joint-like connection between the joystick and the control shafts can in particular be achieved in a further development of the invention by a sliding guidance at the joint which extends in a plane parallel to one of the two control shafts. In accordance with an advantageous embodiment of the invention, a first joint part can be connected rigidly to the joystick and can be tiltably connected to a pivot axle extending transversely thereto, whereas a second joint part is connected rigidly to the other control shaft and has a slot guidance in which the first joint part or the joystick rigidly connected thereto is guided. Movements of the joystick in the longitudinal direction of the slot guidance are not transmitted to the second joint part and thus to the control shaft connected thereto, whereas joystick movements perpendicular to the longitudinal axis of the slot guidance are indeed transmitted to the second joint part and the control shaft fastened thereto.

The slot guidance does not necessarily have to be provided between the joystick and the said second joint part in this process. Alternatively, the slot guidance can also be provided between the second joint part and the second control shaft so that the second joint part is admittedly rotationally fixedly connected to the second control shaft, but can pivot around an axis perpendicular thereto. The said second pivot part is in this case connected to the first joint part and/or to the second joystick.

In a further development of the invention, the two control shafts extend perpendicular to one another, with the joint being made such that the two pivot axes of the joint each stand perpendicular to one of the two control shafts.

The second joint part can generally have a different design. An advantageous embodiment of the invention can consist of the fact that the second joint part has an at least half-shell shaped hoop which engages around the first control shaft and has a longitudinal slot through which the joystick or the other joint part rigidly connected thereto extends.

The hoop is preferably made with two shells to achieve a double load path and thus to increase safety.

The slotted hoop can be doubly journaled. It is preferably rotatably journaled on oppositely disposed sides or is connected to the associated second control shaft. The double journaling of the hoop allows its movements to be picked up doubly or to attach different sensor and/or actuator components. In addition to a simply redundant design, a simple conversion capability can also hereby be achieved.

The other control shaft preferably also has two outputs which can be picked up to be able to attach corresponding components.

The rack can generally have a different design. For example, a correspondingly shaped carrier can be sufficient with which the control apparatus can be installed on a control panel or the like. In accordance with an advantageous embodiment of the invention, the rack can form a housing in which at least the joint is received. In a further development of the invention, actuator motors can also be accommodated in the housing and can be fastened to the housing walls and their motor shafts can form the control shafts. Additional sensor or actuator sensors can be installed at the outer side of the housing, with the control shafts being accessible from the outside by corresponding cut-outs in the housing. The housing so-to-say forms a base box to which the additional control components can be attached in modular form.

In a further development of the invention, centering springs and/or damping elements in the housing can be dispensed with. All the sensors and the electric motors as well as the dampers and centering springs can be flanged externally and in a fixed manner to the control shafts.

The invention will be explained in more detail in the following with respect to a preferred embodiment and to an associated drawing. There is shown in the only drawing:

### BRIEF DESCRIPTION OF THE DRAWING

FIG. 1: a perspective view of the control apparatus comprising a joystick and its joint-like connection to two control shafts.

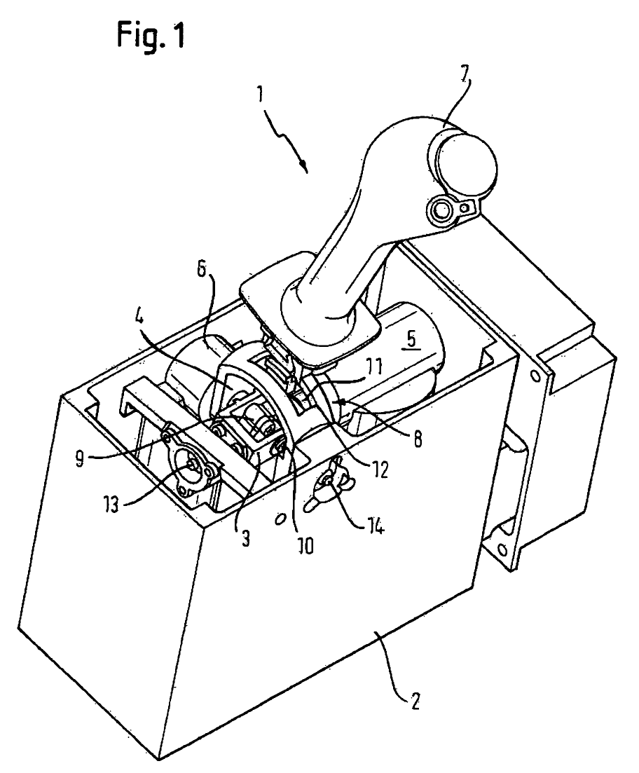

### DESCRIPTION OF THE PREFERRED EMBODIMENT

The control apparatus 1 drawn in the FIGURE comprises a box-shaped housing 2 in which two control shafts 3 and 4 are journaled in a fixed manner, with the control shafts 3 and 4, however, naturally being rotatably journaled so that they can be rotated around their longitudinal axes. In the drawn embodiment, actuator motors 5 and 6, which are likewise received in the interior of the housing 2 and are rigidly installed to it, are flanged to the two control shafts 3 and 4.

A joystick 7 is connected to the two control shafts 3 and 4 via a Cardan-like joint 8 having two pivot axes extending transversely to one another. The joint 8 is made such that the two pivot axes stand perpendicular to one another and coincide with the two fixedly installed control shafts 3 and 4.

Specifically, the joint 8 in the drawn embodiment comprises a first joint part 9 which is connected to the first control shaft 3, and indeed around a transverse axis 10 extending perpendicular to the said first control shaft 3 so that the joystick can be tilted to the front and to the rear in a plane containing the first control shaft 3.

A second joint part 11 is formed in the drawn embodiment as a substantially U-shaped or half-shell shaped hoop which is rotationally fixedly connected to the second control shaft 4. As the FIGURE shows, the hoop-like second joint part 11 engages around the first control shaft 3 and is rotatably journaled at its oppositely disposed limbs, and indeed around the axis of rotation defined by the second control shaft 4.

The two joint parts 9 and 11 are coupled to one another by a sliding guidance 12 which extends in a plane containing the second control shaft 4. Specifically, in the drawn embodiment, the sliding guidance 12 comprises a longitudinal slot in the connector limb of the hoop-shaped second joint part 11 through which the joystick 7 or the first joint part 9 rigidly connected thereto extends. The first joint part 9 receives a freewheel in a plane containing the second control shaft 4 with respect to the second joint part 11 by the sliding guidance 12. In a plane perpendicular thereto containing the first control shaft 3, the two joint parts 9 and 11 are, in contrast, coupled by the sliding guidance 12, i.e. the first joint part 9 or the joystick 7 takes along the second joint part 11 on movements to the front and rear in the plane containing the first control shaft 3.

As the FIGURE shows, the two control shafts 3 and 4 are virtually each rotatably journaled on both sides of the joint 8. On the one hand, pivot bearings 13 and 14 are provided. On the other hand, the control shafts 3 and 4 are rotatably journaled by the actuator motors 5 and 6.

The arrangement described provides a variety of advantages. It must first be set forth that the sensor system or actuator system is installed in a fixed manner at the housing so that no moving connector lines, sliding contacts or the like are needed. High safety is achieved by double load paths and a low seizing probability. In addition, the moved masses are low due to the fixedly arranged control shafts 3 and 4. In addition to high reliability, a simple inner structure is achieved due to a low number of components. In particular a modular utilization of the control apparatus 1 is possible both as an active and as a passive joystick in that in each case the suitable sensor components and actuator components are attached. Furthermore, any desired redundant utilization is opened up by the possibility of providing further elements such as e.g. sensors, motors, switches, etc. on both sides of the joint bearing.

1. A control apparatus for an aircraft comprising a multiaxially tiltable joystick (7) for the actuation of at least two control transducers for the pitch and roll control of the aircraft, with the control transducers being associated with two control shafts (3, 4) which are connected to the joystick (7) via a Cardan-like joint (8) with two pivot axes aligned transversely to one another, with a pitch movement of the joystick (7) being able to be converted via said joint into a rotation of the one control shaft (3) and a roll movement of the joystick (7) being able to be converted into a rotation of the other control shaft (4), wherein
the two control shafts (3, 4) are rotatably journaled in a fixed manner at a common rack (2) and in that the joint (8) in each case has a freewheel with respect to the control shafts (3, 4) for tilt movements of the joystick (7) in a plane parallel to the respective control shaft (3, 4).

2. A control apparatus in accordance with claim 1, wherein the joint (8) has a sliding guidance (12) in a plane parallel to one of the control shafts (4).

3. A control apparatus in accordance with claim 1, wherein the two control shafts (3, 4) are arranged perpendicular to one another; and wherein the two pivot axes of the joint (8) each stand perpendicular to one of the two control shafts (3, 4).

4. A control apparatus in accordance with claim 1, wherein a first joint part (9) is rigidly connected to the joystick (7) and is tiltably connected to a first of the two control shafts (3) around a pivot axis (10) extending perpendicular thereto; and wherein a second joint part (11) is connected in a rotationally fixed manner, in particular rigidly, to the second of the two control shafts (4) and has a slot guidance in which the first joint part (9) and/or the joystick (7) is displaceably guided parallel to the second control shaft (4).

5. A control apparatus in accordance with claim 4, wherein the second joint part (11) has an at least half-shell shaped hoop which engages around the first control shaft (3) and has a longitudinal slot (12) through which the joystick (7) extends.

6. A control apparatus in accordance with claim 5, wherein the hoop (11) is rotatably journaled on oppositely disposed sides and has connector points for a control shaft or for sensor components and/or actuator components which can be coupled thereto.

7. A control apparatus in accordance with claim 1, wherein the two control shafts (3,4) have connector points on both sides.

8. A control apparatus in accordance with claim 1, wherein equipment modules and/or equipment groups can be coupled to the control shafts (3, 4) and/or can be installed at the rack (2) in a modular manner.

9. A control apparatus in accordance with claim 1, wherein actuator motors (5, 6) can be coupled to the control shafts (3, 4) and can be installed at the rack.

10. A control apparatus in accordance with claim 1, wherein damping elements and/or centering springs can be coupled to the control shafts (3, 4) and can be installed at the rack (2).

11. A control apparatus in accordance with claim 1, wherein the rack (2) forms a housing in which the joint (8) is accommodated.

12. A control apparatus in accordance with claim 11, wherein the interior of the housing (2) is made free of damper elements and/or of centering springs; and/or wherein the housing (2) has connection points at its outer side for the installation of sensor elements, damping elements, restoring spring elements and/or other sensor components and/or actuator components.

13. A control apparatus in accordance with claim 11, wherein actuator motors (5, 6) connected to the control shafts (3, 4) are accommodated in the housing (2).

14. A control apparatus in accordance with claim 12, wherein the two joint parts (9, 11) of the joint (8) are each made as a double load path.

15. A control apparatus in accordance with claim 12, wherein actuator motors (5, 6) connected to the control shafts (3, 4) are accommodated in the housing (2).

16. A control apparatus in accordance with claim 15, wherein the two joint parts (9, 11) of the joint (8) are each made as a double load path.

17. A control apparatus in accordance with claim 13, wherein the two joint parts (9, 11) of the joint (8) are each made as a double load path.

18. A control apparatus in accordance with claim 2, wherein the two control shafts (3, 4) are arranged perpendicular to one another; and wherein the two pivot axes of the joint (8) each stand perpendicular to one of the two control shafts (3, 4).

19. A control apparatus in accordance with claim 18, wherein a first joint part (9) is rigidly connected to the joystick (7) and is tiltably connected to a first of the two control shafts (3) around a pivot axis (10) extending perpendicular thereto; and wherein a second joint part (11) is connected in a rotationally fixed manner, in particular rigidly, to the second of the two control shafts (4) and has a slot guidance in which the first joint part (9) and/or the joystick (7) is displaceably guided parallel to the second control shaft (4).

20. A control apparatus in accordance with claim 3, wherein a first joint part (9) is rigidly connected to the joystick (7) and is tiltably connected to a first of the two control shafts (3) around a pivot axis (10) extending perpendicular thereto; and wherein a second joint part (11) is connected in a rotationally fixed manner, in particular rigidly, to the second of the two control shafts (4) and has a slot guidance in which the first joint part (9) and/or the joystick (7) is displaceably guided parallel to the second control shaft (4).
